(19) United States
(12) Patent Application Publication
(10) Pub. No.: US 2019/0104755 A1
(43) Pub. Date: Apr. 11, 2019

(54) METHOD OF MAKING TOMATO WATER

(71) Applicant: Marie Krane, Chicago, IL (US)

(72) Inventor: Marie Krane, Chicago, IL (US)

(21) Appl. No.: 15/725,832

(22) Filed: Oct. 5, 2017

(51) Int. Cl. A23L 2/12; A23L 19/00; A23B 7/045

(52) U.S. Cl. CPC A23L 2/12; A23V 2002/00; A23B 7/045; A23L 19/09

(57) ABSTRACT

Disclosed and claimed here is a method of making substantially solid-free and clear tomato water, comprising the steps of mincing whole tomatoes into pulp and liquid, thereafter removing at least some of the pulp from the resulting pulp/liquid material, thereafter freezing the filtered pulp liquid material into a solid material, thereafter maintaining the frozen solid material in its frozen state for at least 24 hours at a temperature at or below 20° F., thereafter thawing the frozen material, thereafter allowing the thawed material to rest until the material separates into a clear tomato water top layer and a particulate bottom layer, and thereafter drawing off the clear tomato water.

### BACKGROUND OF THE INVENTION

This invention relates to a method of making tomato water, and more particularly concerns a method of making a water-based beverage having the decided taste and bouquet of tomatoes yet having no objectionable color or discernible solid material anywhere in the water.

Pure bottled water is now an important product in grocery and food stores. Everyone knows pure water has no odor, no taste, and no color, and everyone has been taught that pure water is good for you.

But in the constant competition for grocery store shelf space and in restaurant beverage sales, market managers have learned that many consumers want something more than plain water. Many competing water-based beverages contain colorants, dissolved gases, and some homogenized beverages and juices contain fruit or vegetable particulates.

Tomatoes are well known to have a distinctive and pleasing aroma and ingredients which are helpful and pleasing to the consumer. Currently offered traditional tomato juices are opaque, relatively thick, and have a substantial but limited market appeal. There is relatively little market cross-over activity between water-based beverages and traditionally prepared tomato juice.

It is the general object of this invention to provide a tomato water which is clear yet colorful; which has the taste and aroma of highly ripe tomatoes; which is delicious but which contains no discernible solids; and which is preferably prepared from non-hybrid and commercially unattractive tomatoes.

A related object is to encourage the commercial growth of non-hybrid tomatoes and the commercial use of imperfect tomatoes.

Other objects and advantages of this invention will become apparent upon reading the following detailed description and upon reference to the claims.

### DETAILED DESCRIPTION

In a first step of making this novel tomato water, a quantity of preferably non-hybrid tomatoes such as heirloom tomatoes is cut, diced, or otherwise reduced to fine particles and liquid. A juicer appliance or machine can be used to provide this reduction. The juicer or machine removes seeds and skin from the juice.

Thereafter the resulting juice is frozen until thoroughly solid. For example, the juice can be frozen at 0° F. for 12 to 24 hours.

Thereafter the material is thawed and melted in a refrigerator at approximately 40° F. until all the juice ice has completely melted.

During and after this thawing and melting, liquid/solid separation will occur over a period of time, for example, four hours.

The thawed material is then poured put into a container and left in repose until the material separates into liquid at the top and solids at the bottom.

Thereafter, the liquid is strained from the solids, the liquid is poured off into containers, and the solids are discarded.

If desired, the tomato water and solids then can be heated to 170° Fahrenheit but not above 190° Fahrenheit and simmered for up to fifteen minutes in order to prepare the water for enhanced shelf life stability.

The tomato water is then strained from the solids. The liquid is poured off into containers and the solids are discarded.

If desired, the tomato water product can be preserved with or without citric acid or some other appropriate material.

Flavoring agents such as lime and ginger can be added as desired. The beverage can be carbonated.

I claim:

1. A method of making substantially solid-free and clear tomato water, comprising the steps of:
Mincing whole tomatoes into pulp and liquid,
Removing at least some of the pulp from the resulting pulp/liquid material,
Freezing the filtered pulp liquid material into a solid material,
Maintaining the frozen solid material in its frozen state for at least 24 hours at a temperature at or below 20° F.,
Thawing the frozen material,
Allowing the thawed material to rest until the material separates into a clear tomato water top layer and a particulate bottom layer, and
Drawing off the clear tomato water.

2. A method according to claim 1 including the step of mincing heirloom tomatoes.

3. A method according to claim 1 including the step of mincing non-hybrid tomatoes.

4. A method according to claim 1 including the step of mincing fresh tomatoes.

5. A method according to claim 1 wherein the step of freezing the pulp liquid material includes the step of freezing the liquid material into a completely solid material.

6. A method according to claim 1 including the step of allowing material to melt and thereafter allowing the melted material to rest for at least three hours.

7. A method of making substantially solid-free and clear tomato water, comprising the steps of:
Mincing whole tomatoes into pulp and liquid,
Thereafter removing at least some of the pulp from the resulting pulp/liquid material,
Thereafter freezing the filtered pulp liquid material into a solid material,
Thereafter maintaining the frozen solid material in its frozen state for at least 24 hours at a temperature at or below 20° F.,
Thereafter thawing the frozen material,
Thereafter allowing the thawed material to rest until the material separates into a clear tomato water top layer and a particulate bottom layer, and
Thereafter drawing off the clear tomato water.
